(19) United States
(12) Patent Application Publication
(10) Pub. No.: US 2025/0204334 A1
(43) Pub. Date: Jun. 26, 2025

(54) RATIO OF RED TO FAR-RED LIGHT SUPPLEMENTATION TO ENHANCE PLANT GROWTH IN CONTROLLED ENVIRONMENTS

(71) Applicant: BENSON HILL, INC., St. Louis, MO (US)

(72) Inventors: Lisa NEWMAN, Creve Coeur, MO (US); Edward FISCHER, Cotteville, MO (US); Logan DUNCAN, Maryland Heights, MO (US); Thomas RHANOR, Godfrey, IL (US)

(21) Appl. No.: 18/852,560

(22) PCT Filed: Mar. 31, 2023
(86) PCT No.: PCT/US2023/017052

§ 371 Date: Sep. 30, 2024

Related U.S. Application Data
(60) Provisional application No. 63/326,701, filed on Apr. 1, 2022.

(51) Int. Cl. A01G 7/04; H05B 47/155

(52) U.S. Cl. CPC A01G 7/045; H05B 47/155

(57) ABSTRACT

The present invention is directed at a method to enhance the growth of a plant in a controlled growing environment by using light sources which illuminate the plant. The method involves selecting a first frequency and first intensity for the light source, then selecting a second frequency and a second intensity for the light source, and maintaining the first and second intensities at a predetermined ratio. The first frequency may be selected from the range of approximately 620 to approximately 700 nanometers and the second may be selected from the range of approximately 700 to approximately 750 nanometers. The predetermined ratio may be between 1.73-2.60 and most preferably 1.74.

### CROSS REFERENCE TO RELATED APPLICATION

This application claims the benefit and priority of U.S. Provisional Patent Application Ser. No. 63/326,701 filed Apr. 1, 2022 and entitled “Ratio of Red to Far-Red Light Supplementation to Enhance Plant Growth in Controlled Environments,” the disclosure of which is hereby incorporated by reference in its entirety.

### BACKGROUND

Genomics has been used for decades to develop crops for our food system, but most agricultural companies have focused almost exclusively on increasing the yield of a few crops, resulting in commodity ingredients and a food system based on the quantity of calories available. While focus on quantity is important, that focus resulted in lower nutrient density and changed flavors. Minimal diversity in ingredient options also led food manufacturers to add costly water- and energy-intensive processing steps, and additives like sugar and salt to make up for attributes that were muted in crops over time.

However, consumers are now demanding food choices with simpler ingredients that benefit their health and the health of our planet. Food- and diet-related health issues, including obesity and diabetes, are some of the most widespread health issues today and continue to increase. More than 65% of American adults are either overweight or have obesity and, according to the Centers for Disease Control and Prevention, approximately 90% of Americans do not eat the recommended daily amount of fruits and vegetables. Americans spend more on diet-related illnesses than on food itself.

Moreover, the current food system has a substantial environmental impact on the planet. According to an April 2020 report entitled “Agriculture and climate change” prepared by Mckinsey & Company, twenty-seven percent of total greenhouse gas emissions (e.g., methane and nitrous oxide) are caused by agriculture, with cattle and dairy cows alone contributing eight gigatons of carbon dioxide equivalent (GtCO2e) emissions in 2019. (Accessed Dec. 22, 2021 at https://www.mckinsey.com/˜/media/mckinsey/industries/agriculture/our%20insights/reducing%20agriculture%20emissions%20through%20improved%20farming%20practices/agriculture-and-climate-change.pdf.)

At the same time, demand for plant-based solutions to feed the world and improve the environment is growing. Consumers are open to changing their eating habits to minimize further harm to the environment. Moreover, people are actively trying to incorporate more plant-based foods into their diets, especially protein alternatives found in the meat and dairy grocery store sections. NielsenIQ Sep. 9, 2021 article entitled “Growing demand for plant-based proteins” (Accessed Dec. 22, 2021 at https://nielseniq.com/global/en/insights/analysis/2021/examining-shopper-trends-in-plant-based-proteins-accelerating-growth-across-mainstream-channels/).

### Indoor Growth Chambers

In order to meet the world's demands for more environmentally friendly and healthy food varieties, new varieties of many agricultural crops that contain more nutrients, are climate change-tolerant, or that grow faster will be necessary. To facilitate development and discovery of new crop lines, researchers grow new experimental varieties in indoor growth chambers. This allows researchers to control important input factors and make informed decisions when evaluating whether a potential new crop variety is well-suited for large scale cultivation.

To expedite growth, researchers regularly use an indoor light source, such as a high-pressure sodium light, a wide-spectrum LED light, or a narrow-spectrum LED light. Each light source emits a spectrum of light ranging from infra-red light (approximately 700 nm wavelength) to ultraviolet light (approximately 400 nm wavelength). These indoor light arrays allow researchers to control the amount and type of light that plants receive. For example, the standard ratio of red:far-red light in the growing chambers used by Applicant is 11.9. In this manner, researchers can expose plants to light intensities, wavelengths, and durations not possible in an outdoor growing setting.

While indoor growing environments are beneficial to researchers, there are a number of setbacks to using indoor growing facilities as well. They are expensive to operate and researchers must constantly evaluate if the limited indoor space is utilized efficiently. Two limiting factors to the efficiency of indoor growing facilities are the amount of time it takes for a plant to mature and produce viable seeds, and the physical space a plant occupies within the facility.

### Red Light and Far-Red Light

Red light has a wavelength of approximately 620 nm to 700 nm. Far-red light has a wavelength of approximately 700 nm to 780 nm. The photoreceptors in plants, called phytochromes, are sensitive to both red light (phytochrome-red, “Pr”) and far-red light (phytochrome-far red, “Pfr”). In particular, phytochromes act as a micro-switch to help a plant grow towards the sunlight. So, for example, when a plant is in full sunshine, it receives a higher ratio of red to far-red (“red:far-red”) light, approximately 0.6-1.3. When a plant is exposed to this ratio, the Pr phytochrome absorbs red light and is converted into Pfr, which triggers plant growth.

When a plant is shaded by neighboring plants or other objects blocking the sun, the plants receive less red light resulting in a lower red:far-red light ratio. In the shade, Pfr phytochromes absorb far-red light, which is converted into Pr, inhibiting plant growth.

Traditionally, most plant growers have sought to cultivate more robust plants, which tend to be larger, as larger plants are more likely to thrive in their outdoor growing environments. Thus, plant breeders have not focused on plants with shorter stature.

### SUMMARY OF THE DISCLOSURE

The present disclosure is directed to methods of enhancing the growth of a plant in a controlled growing environment with a light source which illuminates the plant. The method comprises (a) selecting a first frequency and a first intensity for the light source, (b) selecting a second frequency and a second intensity for the light source, and (c) maintaining the first and second light intensity at a predetermined ratio.

In some embodiments, the predetermined ratio is between 1.73 and 2.60. In one embodiment, the predetermined ratio is 1.74.

In some embodiments, the first and second light intensity are greater than 800 μmol/m2/second. In some embodiments, the first or second light intensity is greater than 1000 μmol/m2/second.

In some embodiments, the first light source is selected from the range of approximately 620 to approximately 700 nanometers. In some embodiments, the second light source frequency is selected from a range of approximately 700 to approximately 750 nanometers.

These and other aspects of the disclosure will be further explained below.

### DRAWINGS

FIG. 1 illustrates an embodiment of the present disclosure.

FIG. 2 is a graphical representation of the average number of flower nodes per day for soy plants receiving one of three treatments.

FIG. 3 are graphical representations of the average number of flower nodes per day for four maturity groups of soy plants (i.e., Group-1, Group-2, Group-3, and Group-4) each subjected to the same one of the three treatments discussed in association with FIG. 2.

### DETAILED DESCRIPTION

The present invention now will be described more fully hereinafter with reference to the accompanying drawing, which form a part hereof, and which show, by way of illustration, specific exemplary embodiments by which the invention may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods or devices. The following detailed description is, therefore, not to be taken in a limiting sense.

In the following detailed description of embodiments of the inventive concepts, numerous specific details are set forth in order to provide a more thorough understanding of the inventive concepts. However, it will be apparent to one of ordinary skill in the art that the inventive concepts within the disclosure may be practiced without these specific details. In other instances, certain well-known features may not be described in detail to avoid unnecessarily complicating the instant disclosure.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherently present therein.

Unless expressly stated to the contrary, “or” refers to an inclusive or and not to an exclusive or. For example, a condition A or B is satisfied by anyone of the following: A is true (or present) and B is false (or not present), A is false (or not present) and B is true (or present), and both A and B are true (or present).

The term “and combinations thereof” as used herein refers to all permutations or combinations of the listed items preceding the term. For example, “A, B, C, and combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, AAB, BBC, AAABCCCC, CBBAAA, CABABB, and so forth. A person of ordinary skill in the art will understand that typically there is no limit on the number of items or terms in any combination, unless otherwise apparent from the context.

In addition, use of the “a” or “an” are employed to describe elements and components of the embodiments herein. This is done merely for convenience and to give a general sense of the inventive concepts. This description should be read to include one or at least one and the singular also includes the plural unless it is obvious that it is meant otherwise.

The use of the terms “at least one” and “one or more” will be understood to include one as well as any quantity more than one, including, but not limited to, each of, 2, 3, 4, 5, 10, 15, 20, 30, 40, 50, 100, and all integers and fractions, if applicable, therebetween. The terms “at least one” and “one or more” may extend up to 100 or 1000 or more, depending on the term to which it is attached; in addition, the quantities of 100/1000 are not to be considered limiting, as higher limits may also produce satisfactory results.

Further, as used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

As used herein qualifiers such as “about,” “approximately,” and “substantially” are intended to signify that the item being qualified is not limited to the exact value specified, but includes some slight variations or deviations therefrom, caused by measuring error, manufacturing tolerances, stress exerted on various parts, wear and tear, and combinations thereof, for example.

As used herein, a “mutation” is any change in a nucleic acid sequence. Nonlimiting examples comprise insertions, deletions, duplications, substitutions, inversions, and translocations of any nucleic acid sequence, regardless of how the mutation is brought about and regardless of how or whether the mutation alters the functions or interactions of the nucleic acid. For example and without limitation, a mutation may produce altered enzymatic activity of a ribozyme, altered base pairing between nucleic acids (e.g. RNA interference interactions, DNA-RNA binding, etc.), altered mRNA folding stability, and/or how a nucleic acid interacts with polypeptides (e.g. DNA-transcription factor interactions, RNA-ribosome interactions, gRNA-endonuclease reactions, etc.). A mutation might result in the production of proteins with altered amino acid sequences (e.g. missense mutations, nonsense mutations, frameshift mutations, etc.) and/or the production of proteins with the same amino acid sequence (e.g. silent mutations). Certain synonymous mutations may create no observed change in the plant while others that encode for an identical protein sequence nevertheless result in an altered plant phenotype (e.g. due to codon usage bias, altered secondary protein structures, etc.). Mutations may occur within coding regions (e.g., open reading frames) or outside of coding regions (e.g., within promoters, terminators, untranslated elements, or enhancers), and may affect, for example and without limitation, gene expression levels, gene expression profiles, protein sequences, and/or sequences encoding RNA elements such as tRNAs, ribozymes, ribosome components, and microRNAs.

Methods disclosed herein are not limited to mutations made in the genomic DNA of the plant nucleus. For example, in certain embodiments a mutation is created in the genomic DNA of an organelle (e.g. a plastid and/or a mitochondrion). In certain embodiments, a mutation is created in extrachromosomal nucleic acids (including RNA) of the plant, cell, or organelle of a plant. Nonlimiting examples include creating mutations in supernumerary chromosomes (e.g. B chromosomes), plasmids, and/or vector constructs used to deliver nucleic acids to a plant. It is anticipated that new nucleic acid forms will be developed and yet fall within the scope of the claimed invention when used with the teachings described herein.

Methods disclosed herein are not limited to certain techniques of mutagenesis. Any method of creating a change in a nucleic acid of a plant can be used in conjunction with the disclosed invention, including the use of chemical mutagens (e.g. methanesulfonate, sodium azide, aminopurine, etc.), genome/gene editing techniques (e.g. CRISPR-like technologies, TALENs, zinc finger nucleases, and meganucleases), ionizing radiation (e.g. ultraviolet and/or gamma rays) temperature alterations, long-term seed storage, tissue culture conditions, targeting induced local lesions in a genome, sequence-targeted and/or random recombinases, etc. It is anticipated that new methods of creating a mutation in a nucleic acid of a plant will be developed and yet fall within the scope of the claimed invention when used with the teachings described herein.

Similarly, the embodiments disclosed herein are not limited to certain methods of introducing nucleic acids into a plant and are not limited to certain forms or structures that the introduced nucleic acids take. Any method of transforming a cell of a plant described herein with nucleic acids are also incorporated into the teachings of this innovation, and one of ordinary skill in the art will realize that the use of particle bombardment (e.g. using a gene-gun), Agrobacterium infection and/or infection by other bacterial species capable of transferring DNA into plants (e.g., Ochrobactrum sp., Ensifer sp., Rhizobium sp.), viral infection, and other techniques can be used to deliver nucleic acid sequences into a plant described herein. Methods disclosed herein are not limited to any size of nucleic acid sequences that are introduced, and thus one could introduce a nucleic acid comprising a single nucleotide (e.g. an insertion) into a nucleic acid of the plant and still be within the teachings described herein. Nucleic acids introduced in substantially any useful form, for example, on supernumerary chromosomes (e.g. B chromosomes), plasmids, vector constructs, additional genomic chromosomes (e.g. substitution lines), and other forms is also anticipated. It is envisioned that new methods of introducing nucleic acids into plants and new forms or structures of nucleic acids will be discovered and yet fall within the scope of the claimed invention when used with the teachings described herein.

Methods disclosed herein include conferring desired traits to plants, for example, by mutating sequences of a plant, introducing nucleic acids into plants, using plant breeding techniques and various crossing schemes, etc. These methods are not limited as to certain mechanisms of how the plant exhibits and/or expresses the desired trait. In certain nonlimiting embodiments, the trait is conferred to the plant by introducing a nucleotide sequence (e.g. using plant transformation methods) that encodes production of a certain protein by the plant. In certain nonlimiting embodiments, the desired trait is conferred to a plant by causing a null mutation in the plant's genome (e.g. when the desired trait is reduced expression or no expression of a certain trait). In certain nonlimiting embodiments, the desired trait is conferred to a plant by crossing two plants to create offspring that express the desired trait. It is expected that users of these teachings will employ a broad range of techniques and mechanisms known to bring about the expression of a desired trait in a plant. Thus, as used herein, conferring a desired trait to a plant is meant to include any process that causes a plant to exhibit a desired trait, regardless of the specific techniques employed.

As used herein, “fertilization” and/or “crossing” broadly includes bringing the genomes of gametes together to form zygotes but also broadly may include pollination, syngamy, fecundation and other processes related to sexual reproduction. Typically, a cross and/or fertilization occurs after pollen is transferred from one flower to another, but those of ordinary skill in the art will understand that plant breeders can leverage their understanding of fertilization and the overlapping steps of crossing, pollination, syngamy, and fecundation to circumvent certain steps of the plant life cycle and yet achieve equivalent outcomes, for example, a plant or cell of a soybean cultivar described herein. In certain embodiments, a user of this innovation can generate a plant of the claimed invention by removing a genome from its host gamete cell before syngamy and inserting it into the nucleus of another cell. While this variation avoids the unnecessary steps of pollination and syngamy and produces a cell that may not satisfy certain definitions of a zygote, the process falls within the definition of fertilization and/or crossing as used herein when performed in conjunction with these teachings. In certain embodiments, the gametes are not different cell types (i.e. egg vs. sperm), but rather the same type and techniques are used to effect the combination of their genomes into a regenerable cell. Other embodiments of fertilization and/or crossing include circumstances where the gametes originate from the same parent plant, i.e. a “self” or “self-fertilization”. While selfing a plant does not require the transfer pollen from one plant to another, those of skill in the art will recognize that it nevertheless serves as an example of a cross, just as it serves as a type of fertilization. Thus, methods and compositions taught herein are not limited to certain techniques or steps that must be performed to create a plant or an offspring plant of the claimed invention, but rather include broadly any method that is substantially the same and/or results in compositions of the claimed invention.

A plant refers to a whole plant, any part thereof, or a cell or tissue culture derived from a plant, comprising any of: whole plants, plant components or organs (e.g., leaves, stems, roots, etc.), plant tissues, seeds, plant cells, protoplasts and/or progeny of the same. A plant cell is a biological cell of a plant, taken from a plant or derived through culture of a cell taken from a plant.

A population means a set comprising any number, including one, of individuals, objects, or data from which samples are taken for evaluation, e.g. estimating QTL effects and/or disease tolerance. Most commonly, the terms relate to a breeding population of plants from which members are selected and crossed to produce progeny in a breeding program. A population of plants can include the progeny of a single breeding cross or a plurality of breeding crosses and can be either actual plants or plant derived material, or in silico representations of plants. The member of a population need not be identical to the population members selected for use in subsequent cycles of analyses nor does it need to be identical to those population members ultimately selected to obtain a final progeny of plants. Often, a plant population is derived from a single biparental cross but can also derive from two or more crosses between the same or different parents. Although a population of plants can comprise any number of individuals, those of skill in the art will recognize that plant breeders commonly use population sizes ranging from one or two hundred individuals to several thousand, and that the highest performing 5-20% of a population is what is commonly selected to be used in subsequent crosses in order to improve the performance of subsequent generations of the population in a plant breeding program.

Crop performance is used synonymously with plant performance and refers to how well a plant grows under a set of environmental conditions and cultivation practices. Crop performance can be measured by any metric a user associates with a crop's productivity (e.g. yield), appearance and/or robustness (e.g. color, morphology, height, biomass, maturation rate), product quality (e.g. fiber lint percent, fiber quality, seed protein content, seed carbohydrate content, etc.), cost of goods sold (e.g. the cost of creating a seed, plant, or plant product in a commercial, research, or industrial setting) and/or a plant's tolerance to disease (e.g. a response associated with deliberate or spontaneous infection by a pathogen) and/or environmental stress (e.g. drought, flooding, low nitrogen or other soil nutrients, wind, hail, temperature, day length, etc.). Crop performance can also be measured by determining a crop's commercial value and/or by determining the likelihood that a particular inbred, hybrid, or variety will become a commercial product, and/or by determining the likelihood that the offspring of an inbred, hybrid, or variety will become a commercial product. Crop performance can be a quantity (e.g. the volume or weight of seed or other plant product measured in liters or grams) or some other metric assigned to some aspect of a plant that can be represented on a scale (e.g. assigning a 1-10 value to a plant based on its disease tolerance).

A microbe will be understood to be a microorganism, i.e. a microscopic organism, which can be single celled or multicellular. Microorganisms are very diverse and include all the bacteria, archaea, protozoa, fungi, and algae, especially cells of plant pathogens and/or plant symbionts. Certain animals are also considered microbes, e.g. rotifers. In various embodiments, a microbe can be any of several different microscopic stages of a plant or animal. Microbes also include viruses, viroids, and prions, especially those which are pathogens or symbionts to crop plants.

A fungus includes any cell or tissue derived from a fungus, for example whole fungus, fungus components, organs, spores, hyphae, mycelium, and/or progeny of the same. A fungus cell is a biological cell of a fungus, taken from a fungus or derived through culture of a cell taken from a fungus.

A pest is any organism that can affect the performance of a plant in an undesirable way. Common pests include microbes, animals (e.g. insects and other herbivores), and/or plants (e.g. weeds). Thus, a pesticide is any substance that reduces the survivability and/or reproduction of a pest, e.g. fungicides, bactericides, insecticides, herbicides, and other toxins.

Tolerance or improved tolerance in a plant to disease conditions (e.g. growing in the presence of a pest) will be understood to mean an indication that the plant is less affected by the presence of pests and/or disease conditions with respect to yield, survivability and/or other relevant agronomic measures, compared to a less tolerant, more “susceptible” plant. Tolerance is a relative term, indicating that a “tolerant” plant survives and/or performs better in the presence of pests and/or disease conditions compared to other (less tolerant) plants (e.g., a different soybean cultivar) grown in similar circumstances. As used in the art, tolerance is sometimes used interchangeably with “resistance”, although resistance is sometimes used to indicate that a plant appears maximally tolerant to, or unaffected by, the presence of disease conditions. Plant breeders of ordinary skill in the art will appreciate that plant tolerance levels vary widely, often representing a spectrum of more-tolerant or less-tolerant phenotypes, and are thus trained to determine the relative tolerance of different plants, plant lines or plant families and recognize the phenotypic gradations of tolerance.

A plant, or its environment, can be contacted with a wide variety of “agriculture treatment agents.” As used herein, an “agriculture treatment agent”, or “treatment agent”, or “agent” can refer to any exogenously provided compound that can be brought into contact with a plant tissue (e.g. a seed) or its environment that affects a plant's growth, development and/or performance, including agents that affect other organisms in the plant's environment when those effects subsequently alter a plant's performance, growth, and/or development (e.g. an insecticide that kills plant pathogens in the plant's environment, thereby improving the ability of the plant to tolerate the insect's presence). Agriculture treatment agents also include a broad range of chemicals and/or biological substances that are applied to seeds, in which case they are commonly referred to as seed treatments and/or seed dressings. Seed treatments are commonly applied as either a dry formulation or a wet slurry or liquid formulation prior to planting and, as used herein, generally include any agriculture treatment agent including growth regulators, micronutrients, nitrogen-fixing microbes, and/or inoculants. Agriculture treatment agents include pesticides (e.g. fungicides, insecticides, bactericides, etc.) hormones (abscisic acids, auxins, cytokinins, gibberellins, etc.) herbicides (e.g. glyphosate, atrazine, 2,4-D, dicamba, etc.), nutrients (e.g. a plant fertilizer), and/or a broad range of biological agents, for example a seed treatment inoculant comprising a microbe that improves crop performance, e.g. by promoting germination and/or root development. In certain embodiments, the agriculture treatment agent acts extracellularly within the plant tissue, such as interacting with receptors on the outer cell surface. In some embodiments, the agriculture treatment agent enters cells within the plant tissue. In certain embodiments, the agriculture treatment agent remains on the surface of the plant and/or the soil near the plant. In certain embodiments, the agriculture treatment agent is contained within a liquid. Such liquids include, but are not limited to, solutions, suspensions, emulsions, and colloidal dispersions. In some embodiments, liquids described herein will be of an aqueous nature. However, in various embodiments, such aqueous liquids that comprise water can also comprise water insoluble components, can comprise an insoluble component that is made soluble in water by addition of a surfactant, or can comprise any combination of soluble components and surfactants. In certain embodiments, the application of the agriculture treatment agent is controlled by encapsulating the agent within a coating, or capsule (e.g. microencapsulation). In certain embodiments, the agriculture treatment agent comprises a nanoparticle and/or the application of the agriculture treatment agent comprises the use of nanotechnology.

In certain embodiments, plants disclosed herein can be modified to exhibit at least one desired trait, and/or combinations thereof. The disclosed innovations are not limited to any set of traits that can be considered desirable, but nonlimiting examples include male sterility, herbicide tolerance, pest tolerance, disease tolerance, modified fatty acid metabolism, modified carbohydrate metabolism, modified seed yield, modified seed oil, modified seed protein, modified lodging resistance, modified shattering, modified iron-deficiency chlorosis, modified water use efficiency, and/or combinations thereof. Desired traits can also include traits that are deleterious to plant performance, for example, when a researcher desires that a plant exhibits such a trait in order to study its effects on plant performance.

In certain embodiments, a user can combine the teachings herein with high-density molecular marker profiles spanning substantially the entire soybean genome to estimate the value of selecting certain candidates in a breeding program in a process commonly known as genomic selection.

To enhance plant growth in a controlled environment, a method of selecting a ratio of red:far-red light supplementation is utilized. Each step of the method is disclosed below. A ratio of red:far-red light for enhanced soybean growth in a controlled environment is also disclosed.

Red-Light Selection. An intensity and wavelength of red light are selected. Preferably, plants in the controlled growth environment are exposed to a consistent intensity and duration of red light with wavelength approximately 625 nm-700 nm and with a photosynthetic photon density flux of preferably 430-470 μmol/m²/second. It is also possible to expose plants to higher amounts of red light, or varying intensities and durations of red light, however, any variation in red light exposure will result in an adjustment to far-red exposure.

Light intensity is preferably measured with a handheld spectrometer, such as the LI-COR LI-180. However, it is contemplated that intensity across one or more wavelengths may be measured using a spectrometer mounted to a permanent or semi-permanent structure. Regardless of the means, the light intensity is measured at a fixed height, preferably about 32 inches from the ground. That height has been selected because it is approximately the same elevation as the plant base.

Far-Red Light Selection/Ratio of Red:Far-Red. An intensity and wavelength of approximately 700 nm-750 nm of far-red light are selected, such that ratio of red:far-red light selected for enhanced plant growth in a controlled growing environment is between 1.73-2.60, and most preferably 1.74. In other words, taking the presently most preferred embodiment, the intensity of the red light is nearly twice (i.e., 1.73 times) the intensity of the far-red light. Ratios of red:far-red light between approximately 1.73 and approximately 2.12 have been observed and resulted in shorter phenotypes (than would otherwise be expected) as well as faster flowering and increased seed production across all varieties of soybean. Based on other observations, at a ratio of 2.60, Applicant believes the desired benefits of this treatment will still be recognized, however issues with short internode length and pollination success are likely to be observed as the ratio of red:far-red increases (causing the stature of the plants to decrease). The wavelength of far-red light is preferably uniform so that all plants are exposed to the same wavelength of far-red light.

Growth. Preferably, plants are grown under short-day conditions and receive less than 12 hours of light in a given 24-hour period. Total light received was approximately 980-1060 μmol/m2/second. It is also possible to grow plants in long-day conditions, where plants receive more than 14 hours of light in a given 24-hour period at approximately the same total light intensity.

Blue Light Supplementation. A ratio of supplemental blue light may also have beneficial impacts on plant growth in a controlled growth environment. Researchers anticipate a particular ratio of blue light with a wavelength between 450 to 495 nm may further impact growth in a controlled environment.

Ongoing Testing. Red, Far-Red, Blue and other color lights may be selected and positioned so as to expose plants to a gradient of intensities of red/far-red/blue light, with the intensity of each being preferably measured in μmol/m²/second. The resulting gradient(s) of light will result in different ratios of light intensity, for instance, of red:far-red light. It is also possible for a single exposure amount of far-red light instead of a gradient of far-red light exposure to be used. When no gradient is used, the resulting data are more limited and provide information about only one ratio of red:far-red light. In addition to a gradient, plants may be introduced to the supplementary light at various points in their development. So, for example, researchers may introduce plants to the red:far-red/blue supplementation after a certain number of days after planting or grow plants in the red:far-red/blue supplemental light until the plants mature to a desired level. Additional testing may occur among diverse varieties, that is, varieties with differing photo-sensitivities, to determine if a response to the red:far-red light ratio supplementation is generalized.

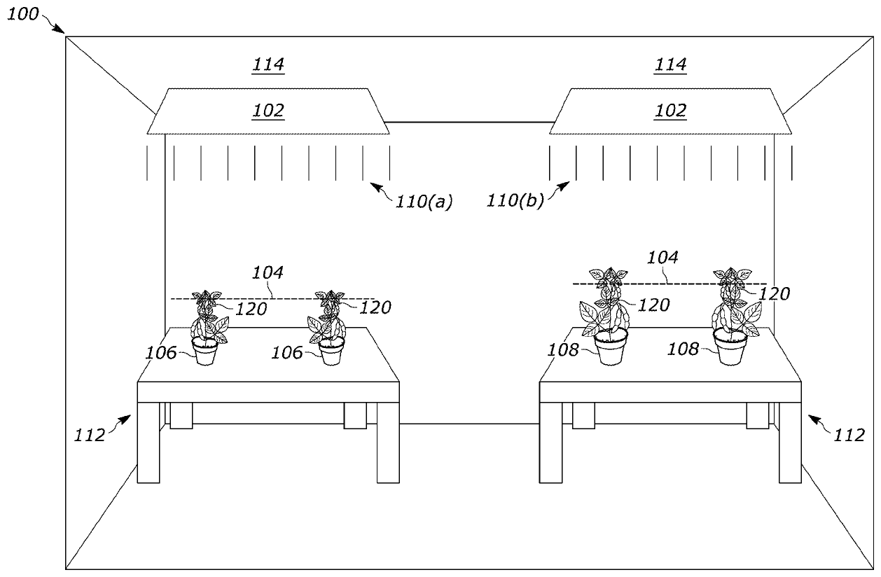

One embodiment of the method is illustrated in FIG. 1. In this embodiment, soybean plants 120 are positioned on growing tables 112 in an environmental growing chamber such that the plants 120 can receive light treatment 110 from grow lights 102. The grow lights may be any lights capable of providing full spectrum light to plants as well as far-red supplementation. As illustrated in FIG. 1, the plants 120 may be grown in a variety of pot sizes (106, 108). In the embodiment illustrated in FIG. 1, the plants 120 receive full spectrum light having an intensity of approximately 1000 μmol/m²/s and far-red light (i.e., wavelength 700-770 nm) having an intensity of approximately 574 μmol/m²/s resulting in a ratio of red:far-red light of approximately 1.74. The light intensity was measured proximate the canopy 104 of the plants. The light treatment 110 received by each plant 120 may change throughout life cycle of the plants. For example, a plant 120 may receive a light treatment 110 of full spectrum light for the duration of the plant's life and additional far-red light supplementation for a certain number of days of the plants life (such as days 11-36, or days 0-40). The method illustrated in FIG. 1 allowed measurement of data, such as the date of first flowering, average flowering nodes per day, total number of flowers, and other flowering data.

### EXAMPLES

The present invention is illustrated in further detail with reference to the following non-limiting examples.

### Example 1: Soybeans Grown in an Indoor Growing with Three Treatments of Red:Far-Red Light Supplementation

Soybean plants are being grown in a controlled growing environment, where temperature was maintained during the day at 29° C. with 55% relative humidity. At night, temperature was maintained at 19° C. with 60% relative humidity. CO2 was always maintained at ambient levels. Plants were divided into three Treatment Groups: A, B, and C. Data for Example 1 have been collected in accordance with the method disclosed herein.

Applicant grew soybeans to test the effect of the addition of far-red light supplementation on plant flowering in a controlled indoor growing environment, where temperature was maintained during the day at 29° C. and at 19° C. during the night. CO₂ in the was always maintained at ambient levels.

Applicant grew soy plants in three growing conditions: treatment A, treatment B, and treatment C. When applied, each treatment used full-spectrum light with an intensity of approximately 1000 μmol/m²/sec. When applied, each treatment used supplemental far-red light (wavelength approximately 700-770 nm) with an intensity of approximately 574 μmol/m²/sec. The controlled indoor growing environment in treatment A had a relative humidity of 55% during the day and 65% at night. The controlled indoor growing environment in treatments B and C had a relative humidity of 65% during the day and 70% at night.

In Treatment A, soy plants from four maturity groups (MG 1-4) were grown in two pot sizes (3.5 inches and 4.5 inches) under short day conditions (12 hours day, 12 hours night). For days 0-10, plants in treatment group A received no additional red:far-red supplementation. For days 11-36, plants in treatment group A received red:far-red supplementation at a ratio of red:far-red of 1.74.

Treatment B was nearly identical to Treatment A: Soy plants from four maturity groups (MG 1-4) were grown in two pot sizes (3.5 inches and 4.5 inches) under short day conditions (12 hours day, 12 hours night). For days 0-10, plants in Treatment B received no additional red:far-red supplementation. For days 11-36, plants in Treatment B received red:far-red supplementation at a ratio of red:far-red of 1.74. Following day 30, plants in Treatment B were exposed to long day conditions (16 hours of day and 8 hour of night) rather than short day conditions, however the effect of the long day treatment was negligible, as discussed below.

In Treatment C, soy plants from four maturity groups (MG 1-4) were grown in two pot sizes (3.5 inches and 4.5 inches) under short day conditions (12 hours day, 12 hours night). Plants in Treatment C received red:far-red supplementation at a ratio of 1.74 on days 0-40.

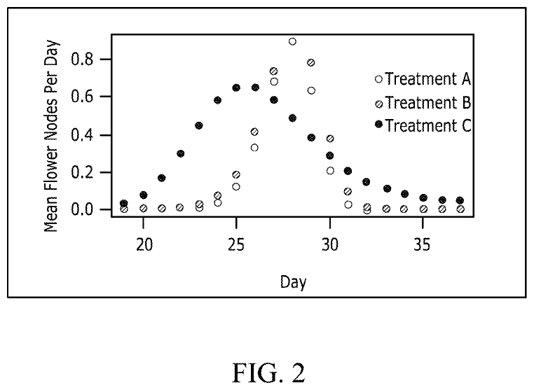

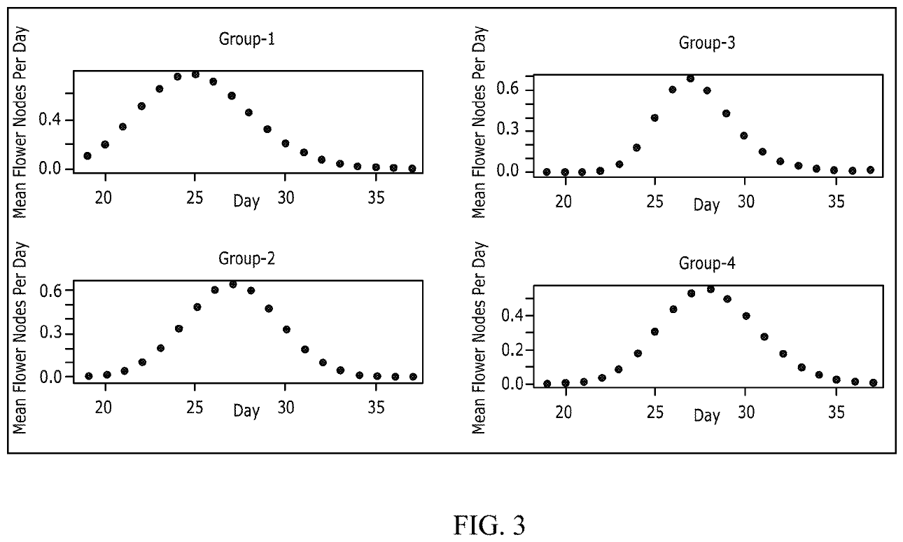

Findings from Example 1 are reported in Tables 1-6 and FIGS. 2 and 3. Days to flowering and lifespan are reported in days.

Treatment A: Short Day Supplemented with Red:Far-Red at 1.74 Applied on Days 11-36 Treatment A Using 3.5-Inch Pots

TABLE 1
(averages for plants by variety and maturity group).

| Soy Variety | MG | Average Days to Flower | Average Lifespan |
|---|---|---|---|
| A | 1 | 28.25 | 84.13 |
| B | 2 | 28.25 | 85 |
| C | 2 | 27.75 | 85 |
| D | 2 | 27.25 | 82.38 |
| E | 2 | 27 | 85 |
| F | 3 | 27.88 | 85 |
| G | 3 | 27 | 78.88 |
| H | 3 | 27.38 | 84.13 |
| J | 3 | 28.5 | 85 |
| K | 4 | 28.62 | 85 |
| L | 4 | 28.5 | 79.75 |
| M | 5 | 31.86 | 85 |

TABLE 1a
Variety A, Maturity Group 1 (individual plant by plant datapoints)

| Plant ID | 1 | 2 | 3 | 4 | 5 | 6 | 7 | 8 |
|---|---|---|---|---|---|---|---|---|
| Days to Flower | 28 | 27 | 30 | 29 | 30 | 27 | 28 | 27 |
| Lifespan (days) | 85 | 85 | 85 | 85 | 85 | 85 | 85 | 78 |

TABLE 1b
Variety B, Maturity Group 2 (individual plant by plant datapoints)

| Plant ID | 9 | 10 | 11 | 12 | 13 | 14 | 15 | 16 |
|---|---|---|---|---|---|---|---|---|
| Days to Flower | 29 | 28 | 27 | 27 | 28 | 28 | 28 | 31 |
| Lifespan (days) | 85 | 85 | 85 | 85 | 85 | 85 | 85 | 85 |

TABLE 1c
Variety C, Maturity Group 2 (individual plant by plant datapoints)

| Plant ID | 17 | 18 | 19 | 20 | 21 | 22 | 23 | 24 |
|---|---|---|---|---|---|---|---|---|
| Days to Flower | 27 | 29 | 28 | 28 | 28 | 27 | 27 | 28 |
| Lifespan (days) | 85 | 85 | 85 | 85 | 85 | 85 | 85 | 85 |

TABLE 1d
Variety D, Maturity Group 2 (individual plant by plant datapoints)

| Plant ID | 25 | 26 | 27 | 28 | 29 | 30 | 31 | 32 |
|---|---|---|---|---|---|---|---|---|
| Days to Flower | 27 | 30 | 29 | 28 | 27 | 27 | 23 | 27 |
| Lifespan (days) | 85 | 85 | 85 | 85 | 85 | 78 | 78 | 78 |

TABLE 1e
Variety E, Maturity Group 2 (individual plant by plant datapoints)

| Plant ID | 33 | 34 | 35 | 36 | 37 | 38 | 39 | 40 |
|---|---|---|---|---|---|---|---|---|
| Days to Flower | 27 | 27 | 27 | 27 | 27 | 27 | 27 | 27 |
| Lifespan (days) | 85 | 85 | 85 | 85 | 85 | 85 | 85 | 85 |

TABLE 1f
Variety F, Maturity Group 3 (individual plant by plant datapoints)

| Plant ID | 41 | 42 | 43 | 44 | 45 | 46 | 47 | 48 |
|---|---|---|---|---|---|---|---|---|
| Days to Flower | 29 | 27 | 27 | 29 | 29 | 27 | 27 | 28 |
| Lifespan (days) | 85 | 85 | 85 | 85 | 85 | 85 | 85 | 85 |

TABLE 1g
Variety G, Maturity Group 3 (individual plant by plant datapoints)

| Plant ID | 49 | 50 | 51 | 52 | 53 | 54 | 55 | 56 |
|---|---|---|---|---|---|---|---|---|
| Days to Flower | 27 | 27 | 27 | 27 | 27 | 27 | 27 | 27 |
| Lifespan (days) | 85 | 78 | 78 | 78 | 78 | 78 | 78 | 78 |

TABLE 1h
Variety H, Maturity Group 3 (individual plant by plant datapoints)

| Plant ID | 57 | 58 | 59 | 60 | 61 | 62 | 63 | 64 |
|---|---|---|---|---|---|---|---|---|
| Days to Flower | 27 | 27 | 28 | 27 | 29 | 28 | 29 | 24 |
| Lifespan (days) | 85 | 85 | 85 | 85 | 85 | 85 | 85 | 78 |

TABLE 1j
Variety J, Maturity Group 3 (individual plant by plant datapoints)

| Plant ID | 65 | 66 | 67 | 68 | 69 | 70 | 71 | 72 |
|---|---|---|---|---|---|---|---|---|
| Days to Flower | 29 | 28 | 29 | 29 | 28 | 29 | 28 | 28 |
| Lifespan (days) | 85 | 85 | 85 | 85 | 85 | 85 | 85 | 85 |

TABLE 1k
Variety K, Maturity Group 2 (individual plant by plant datapoints)

| Plant ID | 73 | 74 | 75 | 76 | 77 | 78 | 79 | 80 |
|---|---|---|---|---|---|---|---|---|
| Days to Flower | 30 | 27 | 30 | 29 | 28 | 27 | 29 | 29 |
| Lifespan (days) | 85 | 85 | 85 | 85 | 85 | 85 | 85 | 85 |

TABLE 1l
Variety L, Maturity Group 4 (individual plant by plant datapoints)

| Plant ID | 81 | 82 | 83 | 84 | 85 | 86 | 87 | 88 |
|---|---|---|---|---|---|---|---|---|
| Days to Flower | 27 | 31 | 31 | 27 | 27 | 28 | 28 | 29 |
| Lifespan (days) | 78 | 85 | 85 | 78 | 78 | 78 | 78 | 78 |

TABLE 1m
Variety M, Maturity Group 5 (individual plant by plant datapoints)

| Plant ID | 89 | 90 | 91 | 92 | 93 | 94 | 95 |
|---|---|---|---|---|---|---|---|
| Days to Flower | 30 | 28 | 34 | 34 | 34 | 29 | 34 |
| Lifespan (days) | 85 | 85 | 85 | 85 | 85 | 85 | 85 |

### Treatment A Using 4.5-Inch Pots

TABLE 2
(averages for plants by variety and maturity group).

| Variety | MG | Average Days to Flower | Average Lifespan |
|---|---|---|---|
| A | 1 | 27.13 | 80.66 |
| B | 2 | 27.25 | 85 |
| C | 2 | 27 | 85 |
| D | 2 | 27 | 85 |
| E | 2 | 25.88 | 85 |
| F | 3 | 27 | 85 |
| G | 3 | 26.38 | 80.63 |
| H | 3 | 26.75 | 85 |
| J | 3 | 28.13 | 85 |
| K | 4 | 27.88 | 85 |
| L | 4 | 27.13 | 80.63 |
| M | 5 | 29.25 | 81.5 |

TABLE 2a
Variety A, Maturity Group 1 (individual plant by plant datapoints)

| Plant ID | 96 | 97 | 98 | 99 | 100 | 101 | 102 | 103 |
|---|---|---|---|---|---|---|---|---|
| Days to Flower | 27 | 27 | 27 | 27 | 27 | 27 | 27 | 28 |
| Lifespan (days) | 78 | 78 | 78 | 78 | 78 | 85 | 85 | 85 |

TABLE 2b
Variety B, Maturity Group 2 (individual plant by plant datapoints)

| Plant ID | 104 | 105 | 106 | 107 | 108 | 109 | 110 | 111 |
|---|---|---|---|---|---|---|---|---|
| Days to Flower | 27 | 27 | 28 | 28 | 27 | 27 | 27 | 27 |
| Lifespan (days) | 85 | 85 | 85 | 85 | 85 | 85 | 85 | 85 |

TABLE 2c
Variety C, Maturity Group 2 (individual plant by plant datapoints)

| Plant ID | 112 | 113 | 114 | 115 | 116 | 117 | 118 | 119 |
|---|---|---|---|---|---|---|---|---|
| Days to Flower | 27 | 27 | 27 | 27 | 27 | 27 | 27 | 27 |
| Lifespan (days) | 85 | 85 | 85 | 85 | 85 | 85 | 85 | 85 |

TABLE 2d
Variety D, Maturity Group 2 (individual plant by plant datapoints)

| Plant ID | 120 | 121 | 122 | 123 | 124 | 125 | 126 | 127 |
|---|---|---|---|---|---|---|---|---|
| Days to Flower | 27 | 27 | 27 | 27 | 27 | 27 | 27 | 27 |
| Lifespan (days) | 85 | 85 | 85 | 85 | 85 | 85 | 85 | 85 |

TABLE 2e
Variety E, Maturity Group 2 (individual plant by plant datapoints)

| Plant ID | 128 | 129 | 130 | 131 | 132 | 133 | 134 | 135 |
|---|---|---|---|---|---|---|---|---|
| Days to Flower | 24 | 27 | 27 | 24 | 27 | 24 | 27 | 27 |
| Lifespan (days) | 85 | 85 | 85 | 85 | 85 | 85 | 85 | 85 |

TABLE 2f
Variety F, Maturity Group 3 (individual plant by plant datapoints)

| Plant ID | 136 | 137 | 138 | 139 | 140 | 141 | 142 |
|---|---|---|---|---|---|---|---|
| Days to Flower | 27 | 27 | 27 | 27 | 27 | 27 | 27 |
| Lifespan (days) | 85 | 85 | 85 | 85 | 85 | 85 | 85 |

TABLE 2g
Variety G, Maturity Group 3 (individual plant by plant datapoints)

| Plant ID | 143 | 144 | 145 | 146 | 147 | 148 | 149 | 150 |
|---|---|---|---|---|---|---|---|---|
| Days to Flower | 29 | 29 | 30 | 27 | 23 | 23 | 27 | 23 |
| Lifespan (days) | 85 | 85 | 85 | 78 | 78 | 78 | 78 | 78 |

TABLE 2h
Variety H, Maturity Group 3 (individual plant by plant datapoints)

| Plant ID | 151 | 152 | 153 | 154 | 155 | 156 | 157 | 158 |
|---|---|---|---|---|---|---|---|---|
| Days to Flower | 24 | 27 | 28 | 27 | 27 | 27 | 27 | 27 |
| Lifespan (days) | 85 | 85 | 85 | 85 | 85 | 85 | 85 | 85 |

TABLE 2j
Variety J, Maturity Group 3 (individual plant by plant datapoints)

| Plant ID | 159 | 160 | 161 | 162 | 163 | 164 | 165 | 166 |
|---|---|---|---|---|---|---|---|---|
| Days to Flower | 29 | 29 | 27 | 28 | 28 | 28 | 27 | 29 |
| Lifespan (days) | 85 | 85 | 85 | 85 | 85 | 85 | 85 | 85 |

TABLE 2k
Variety K, Maturity Group 4 (individual plant by plant datapoints)

| Plant ID | 167 | 168 | 169 | 170 | 171 | 172 | 173 | 174 |
|---|---|---|---|---|---|---|---|---|
| Days to Flower | 27 | 27 | 30 | 28 | 28 | 27 | 27 | 29 |
| Lifespan (days) | 85 | 85 | 85 | 85 | 85 | 85 | 85 | 85 |

TABLE 2l
Variety L, Maturity Group 4 (individual plant by plant datapoints)

| Plant ID | 175 | 176 | 177 | 178 | 179 | 180 | 181 | 182 |
|---|---|---|---|---|---|---|---|---|
| Days to Flower | 27 | 27 | 28 | 24 | 27 | 27 | 27 | 30 |
| Lifespan (days) | 85 | 85 | 78 | 78 | 78 | 78 | 78 | 85 |

TABLE 2m
Variety M, Maturity Group 5 (individual plant by plant datapoints)

| Plant ID | 183 | 184 | 185 | 186 | 187 | 188 | 189 | 190 |
|---|---|---|---|---|---|---|---|---|
| Days to Flower | 27 | 34 | 31 | 27 | 31 | 28 | 27 | 29 |
| Lifespan (days) | 85 | 85 | 85 | 78 | 85 | 78 | 78 | 78 |

Treatment B: Short Day Supplemented with Red:Far-Red at 1.74 Applied on Days 11-36, Long Day Conditions Beginning on Day 30.

### Treatment B Using 3.5-Inch Pots

TABLE 3
(averages for plants by variety and maturity group).

| Variety | MG | Average Days to Flower | Average Lifespan |
|---|---|---|---|
| A | 1 | 28.17 | 101.67 |
| B | 2 | 27.71 | 104 |
| C | 2 | 27.43 | 102 |
| D | 2 | 25.5 | 96 |
| E | 2 | 26 | 104 |
| F | 3 | 27.38 | 104 |
| G | 3 | 27.43 | 100 |
| H | 3 | 28.38 | 104 |
| J | 3 | 27.88 | 104 |
| K | 4 | 28.57 | 104 |
| L | 4 | 29.33 | 102.83 |
| M | 5 | 31.43 | 102 |

TABLE 3a
Variety A, Maturity Group 1 (individual plant by plant datapoints)

| Plant ID | 191 | 192 | 193 | 194 | 195 | 196 |
|---|---|---|---|---|---|---|
| Days to Flower | 28 | 27 | 27 | 27 | 27 | 33 |
| Lifespan (days) | 104 | 104 | 104 | 97 | 97 | 104 |

TABLE 3b
Variety B, Maturity Group 2 (individual plant by plant datapoints)

| Plant ID | 197 | 198 | 199 | 200 | 201 | 202 | 203 |
|---|---|---|---|---|---|---|---|
| Days to Flower | 29 | 27 | 28 | 27 | 27 | 29 | 27 |
| Lifespan (days) | 104 | 104 | 104 | 104 | 104 | 104 | 104 |

TABLE 3c
Variety C, Maturity Group 2 (individual plant by plant datapoints)

| Plant ID | 204 | 205 | 206 | 207 | 208 | 209 | 210 |
|---|---|---|---|---|---|---|---|
| Days to Flower | 27 | 28 | 27 | 28 | 30 | 26 | 26 |
| Lifespan (days) | 104 | 104 | 104 | 104 | 104 | 97 | 97 |

TABLE 3d
Variety D, Maturity Group 2 (individual plant by plant datapoints)

| Plant ID | 211 | 212 | 213 | 214 | 215 | 216 | 217 | 218 |
|---|---|---|---|---|---|---|---|---|
| Days to Flower | 27 | 25 | 26 | 25 | 25 | 25 | 26 | 25 |
| Lifespan (days) | 96 | 96 | 96 | 96 | 96 | 96 | 96 | 96 |

TABLE 3e
Variety E, Maturity Group 2 (individual plant by plant datapoints)

| Plant ID | 219 | 220 | 221 | 222 | 223 | 224 | 225 |
|---|---|---|---|---|---|---|---|
| Days to Flower | 24 | 26 | 26 | 26 | 27 | 26 | 27 |
| Lifespan (days) | 104 | 104 | 104 | 104 | 104 | 104 | 104 |

TABLE 3f
Variety F, Maturity Group 3 (individual plant by plant datapoints)

| Plant ID | 226 | 227 | 228 | 229 | 230 | 231 | 232 | 233 |
|---|---|---|---|---|---|---|---|---|
| Days to Flower | 27 | 28 | 29 | 27 | 27 | 27 | 27 | 27 |
| Lifespan (days) | 104 | 104 | 104 | 104 | 104 | 104 | 104 | 104 |

TABLE 3g
Variety G, Maturity Group 3 (individual plant by plant datapoints)

| Plant ID | 234 | 235 | 236 | 237 | 238 | 239 | 240 |
|---|---|---|---|---|---|---|---|
| Days to Flower | 27 | 30 | 30 | 26 | 26 | 27 | 26 |
| Lifespan (days) | 104 | 104 | 104 | 97 | 97 | 97 | 97 |

TABLE 3h
Variety H, Maturity Group 3 (individual plant by plant datapoints)

| Plant ID | 241 | 242 | 243 | 244 | 245 | 246 | 247 | 248 |
|---|---|---|---|---|---|---|---|---|
| Days to Flower | 28 | 28 | 27 | 27 | 28 | 29 | 29 | 31 |
| Lifespan (days) | 104 | 104 | 104 | 104 | 104 | 104 | 104 | 104 |

TABLE 3j
Variety J, Maturity Group 3 (individual plant by plant datapoints)

| Plant ID | 249 | 250 | 251 | 252 | 253 | 254 | 255 | 256 |
|---|---|---|---|---|---|---|---|---|
| Days to Flower | 27 | 28 | 27 | 28 | 29 | 27 | 28 | 29 |
| Lifespan (days) | 104 | 104 | 104 | 104 | 104 | 104 | 104 | 104 |

TABLE 3k
Variety K, Maturity Group 4 (individual plant by plant datapoints)

| Plant ID | 257 | 258 | 259 | 260 | 261 | 262 | 263 |
|---|---|---|---|---|---|---|---|
| Days to Flower | 29 | 29 | 29 | 28 | 28 | 28 | 29 |
| Lifespan (days) | 104 | 104 | 104 | 104 | 104 | 104 | 104 |

TABLE 3l
Variety L, Maturity Group 4 (individual plant by plant datapoints)

| Plant ID | 264 | 265 | 266 | 267 | 268 | 269 |
|---|---|---|---|---|---|---|
| Days to Flower | 30 | 28 | 30 | 27 | 28 | 33 |
| Lifespan (days) | 104 | 104 | 104 | 104 | 97 | 104 |

TABLE 3m
Variety M, Maturity Group 5 (individual plant by plant datapoints)

| Plant ID | 270 | 271 | 272 | 273 | 274 | 275 | 276 |
|---|---|---|---|---|---|---|---|
| Days to Flower | 33 | 31 | 33 | 33 | 28 | 29 | 33 |
| Lifespan (days) | 104 | 104 | 104 | 104 | 97 | 97 | 104 |

### Treatment B Using 4.5-Inch Pots

TABLE 4
(averages for plants by variety and maturity group).

| Variety | MG | Average Days to Flower | Average Lifespan |
|---|---|---|---|
| A | 1 | 26.83 | 98.17 |
| B | 2 | 26.5 | 104 |
| C | 2 | 27.13 | 104 |
| D | 2 | 25.75 | 104 |
| E | 2 | 24.5 | 104 |
| F | 3 | 26.75 | 104 |
| G | 3 | 26 | 98.75 |
| H | 3 | 26.75 | 102.25 |
| J | 3 | 27.25 | 104 |
| K | 4 | 26.5 | 100.5 |
| L | 4 | 27.67 | 101.67 |
| M | 5 | 31 | 103 |

TABLE 4a
Variety A, Maturity Group 1 (individual plant by plant datapoints)

| Plant ID | 277 | 278 | 279 | 280 | 281 | 282 |
|---|---|---|---|---|---|---|
| Days to Flower | 27 | 27 | 27 | 27 | 27 | 26 |
| Lifespan (days) | 104 | 97 | 97 | 97 | 97 | 97 |

TABLE 4b
Variety B, Maturity Group 2 (individual plant by plant datapoints)

| Plant ID | 283 | 284 | 285 | 286 | 287 | 288 | 289 | 290 |
|---|---|---|---|---|---|---|---|---|
| Days to Flower | 27 | 27 | 26 | 26 | 26 | 26 | 27 | 27 |
| Lifespan (days) | 104 | 104 | 104 | 104 | 104 | 104 | 104 | 104 |

TABLE 4c
Variety C, Maturity Group 2 (individual plant by plant datapoints)

| Plant ID | 291 | 292 | 293 | 294 | 295 | 296 | 297 | 298 |
|---|---|---|---|---|---|---|---|---|
| Days to Flower | 27 | 27 | 27 | 27 | 27 | 27 | 28 | 27 |
| Lifespan (days) | 104 | 104 | 104 | 104 | 104 | 104 | 104 | 104 |

TABLE 4d
Variety D, Maturity Group 2 (individual plant by plant datapoints)

| Plant ID | 299 | 300 | 301 | 302 | 303 | 304 | 305 | 306 |
|---|---|---|---|---|---|---|---|---|
| Days to Flower | 24 | 26 | 26 | 26 | 24 | 27 | 27 | 26 |
| Lifespan (days) | 104 | 104 | 104 | 104 | 104 | 104 | 104 | 104 |

TABLE 4e
Variety E, Maturity Group 2 (individual plant by plant datapoints)

| Plant ID | 307 | 308 | 309 | 310 | 311 | 312 | 313 | 314 |
|---|---|---|---|---|---|---|---|---|
| Days to Flower | 24 | 24 | 26 | 24 | 24 | 24 | 24 | 26 |
| Lifespan (days) | 104 | 104 | 104 | 104 | 104 | 104 | 104 | 104 |

TABLE 4f
Variety F, Maturity Group 3 (individual plant by plant datapoints)

| Plant ID | 315 | 316 | 317 | 318 | 319 | 320 | 321 | 322 |
|---|---|---|---|---|---|---|---|---|
| Days to Flower | 26 | 27 | 27 | 27 | 27 | 27 | 27 | 26 |
| Lifespan (days) | 104 | 104 | 104 | 104 | 104 | 104 | 104 | 104 |

TABLE 4g
Variety G, Maturity Group 3 (individual plant by plant datapoints)

| Plant ID | 323 | 324 | 325 | 326 | 327 | 328 | 329 | 330 |
|---|---|---|---|---|---|---|---|---|
| Days to Flower | 29 | 28 | 26 | 27 | 24 | 26 | 24 | 24 |
| Lifespan (days) | 104 | 104 | 97 | 97 | 97 | 97 | 97 | 97 |

TABLE 4h
Variety H, Maturity Group 3 (individual plant by plant datapoints)

| Plant ID | 331 | 332 | 333 | 334 | 335 | 336 | 337 | 338 |
|---|---|---|---|---|---|---|---|---|
| Days to Flower | 28 | 26 | 26 | 26 | 27 | 26 | 22 | 33 |
| Lifespan (days) | 104 | 104 | 104 | 104 | 104 | 97 | 97 | 104 |

TABLE 4j
Variety J, Maturity Group 3 (individual plant by plant datapoints)

| Plant ID | 339 | 340 | 341 | 342 | 343 | 344 | 345 | 346 |
|---|---|---|---|---|---|---|---|---|
| Days to Flower | 27 | 28 | 27 | 27 | 27 | 27 | 27 | 28 |
| Lifespan (days) | 104 | 104 | 104 | 104 | 104 | 104 | 104 | 104 |

TABLE 4k
Variety K, Maturity Group 4 (individual plant by plant datapoints)

| Plant ID | 347 | 348 | 349 | 350 | 351 | 352 |
|---|---|---|---|---|---|---|
| Days to Flower | 27 | 27 | 27 | 24 | 27 | 27 |
| Lifespan (days) | 104 | 104 | 104 | 97 | 97 | 97 |

TABLE 4l
Variety L, Maturity Group 4 (individual plant by plant datapoints)

| Plant ID | 353 | 354 | 355 | 356 | 357 | 358 |
|---|---|---|---|---|---|---|
| Days to Flower | 27 | 27 | 28 | 30 | 27 | 27 |
| Lifespan (days) | 104 | 104 | 104 | 104 | 97 | 97 |

TABLE 4m
Variety M, Maturity Group 5 (individual plant by plant datapoints)

| Plant ID | 359 | 360 | 361 | 362 | 363 | 364 | 365 |
|---|---|---|---|---|---|---|---|
| Days to Flower | 31 | 33 | 28 | 31 | 34 | 33 | 27 |
| Lifespan (days) | 104 | 104 | 104 | 104 | 104 | 104 | 97 |

Treatment C: Short Day Supplemented with Red:Far-Red at 1.74 Applied Days 0-40

### Treatment C Using 3.5-Inch Pots

TABLE 5
(averages for plants by variety and maturity group).

| Variety | MG | Average Days to Flower | Average Lifespan |
|---|---|---|---|
| A | 1 | 29.25 | 86 |
| B | 2 | 24.38 | 85.5 |
| C | 2 | 23.25 | 84.5 |
| D | 2 | 25.63 | 86.5 |
| E | 2 | 22.63 | 85 |
| F | 3 | 26.38 | 87 |
| G | 3 | 27.25 | 85 |
| H | 3 | 25.86 | 85.86 |
| J | 3 | 27 | 86 |
| K | 4 | 26.88 | 85.5 |
| L | 4 | 29.38 | 86 |
| M | 5 | 31 | 85 |

TABLE 5a
Variety A, Maturity Group 1 (individual plant by plant datapoints)

| Plant ID | 366 | 367 | 368 | 369 | 370 | 371 | 372 | 373 |
|---|---|---|---|---|---|---|---|---|
| Days to Flower | 22 | 24 | 32 | 30 | 30 | 33 | 32 | 31 |
| Lifespan (days) | 83 | 83 | 87 | 87 | 87 | 87 | 87 | 87 |

TABLE 5b
Variety B, Maturity Group 2 (individual plant by plant datapoints)

| Plant ID | 374 | 375 | 376 | 377 | 378 | 379 | 380 | 381 |
|---|---|---|---|---|---|---|---|---|
| Days to Flower | 26 | 22 | 22 | 22 | 25 | 26 | 26 | 26 |
| Lifespan (days) | 87 | 83 | 83 | 83 | 87 | 87 | 87 | 87 |

TABLE 5c
Variety C, Maturity Group 2 (individual plant by plant datapoints)

| Plant ID | 382 | 383 | 384 | 385 | 386 | 387 | 388 | 389 |
|---|---|---|---|---|---|---|---|---|
| Days to Flower | 22 | 22 | 21 | 22 | 25 | 22 | 26 | 26 |
| Lifespan (days) | 83 | 83 | 83 | 83 | 87 | 83 | 87 | 87 |

TABLE 5d
Variety D, Maturity Group 2 (individual plant by plant datapoints)

| Plant ID | 390 | 391 | 392 | 393 | 394 | 395 | 396 | 397 |
|---|---|---|---|---|---|---|---|---|
| Days to Flower | 26 | 21 | 25 | 23 | 24 | 25 | 29 | 32 |
| Lifespan (days) | 87 | 83 | 87 | 87 | 87 | 87 | 87 | 87 |

TABLE 5e
Variety E, Maturity Group 2 (individual plant by plant datapoints)

| Plant ID | 398 | 399 | 400 | 401 | 402 | 403 | 404 | 405 |
|---|---|---|---|---|---|---|---|---|
| Days to Flower | 21 | 21 | 20 | 20 | 25 | 25 | 25 | 24 |
| Lifespan (days) | 83 | 83 | 83 | 83 | 87 | 87 | 87 | 87 |

TABLE 5f
Variety F, Maturity Group 3 (individual plant by plant datapoints)

| Plant ID | 406 | 407 | 408 | 409 | 410 | 411 | 412 | 413 |
|---|---|---|---|---|---|---|---|---|
| Days to Flower | 29 | 28 | 26 | 26 | 26 | 26 | 25 | 25 |
| Lifespan (days) | 87 | 87 | 87 | 87 | 87 | 87 | 87 | 87 |

TABLE 5g
Variety G, Maturity Group 3 (individual plant by plant datapoints)

| Plant ID | 414 | 415 | 416 | 417 | 418 | 419 | 420 | 421 |
|---|---|---|---|---|---|---|---|---|
| Days to Flower | 26 | 25 | 28 | 25 | 29 | 25 | 30 | 30 |
| Lifespan (days) | 83 | 83 | 87 | 83 | 87 | 83 | 87 | 87 |

TABLE 5h
Variety H, Maturity Group 3 (individual plant by plant datapoints)

| Plant ID | 422 | 423 | 424 | 425 | 426 | 427 | 428 |
|---|---|---|---|---|---|---|---|
| Days to Flower | 24 | 24 | 26 | 26 | 26 | 25 | 30 |
| Lifespan (days) | 83 | 83 | 87 | 87 | 87 | 87 | 87 |

TABLE 5j
Variety J, Maturity Group 3 (individual plant by plant datapoints)

| Plant ID | 429 | 430 | 431 | 432 | 433 | 434 | 435 | 436 |
|---|---|---|---|---|---|---|---|---|
| Days to Flower | 26 | 24 | 28 | 26 | 28 | 28 | 28 | 28 |
| Lifespan (days) | 83 | 83 | 87 | 87 | 87 | 87 | 87 | 87 |

TABLE 5k
Variety K, Maturity Group 4 (individual plant by plant datapoints)

| Plant ID | 437 | 438 | 439 | 440 | 441 | 442 | 443 | 444 |
|---|---|---|---|---|---|---|---|---|
| Days to Flower | 25 | 24 | 28 | 25 | 29 | 28 | 28 | 28 |
| Lifespan (days) | 83 | 83 | 87 | 83 | 87 | 87 | 87 | 87 |

TABLE 5l
Variety L, Maturity Group 4 (individual plant by plant datapoints)

| Plant ID | 445 | 446 | 447 | 448 | 449 | 450 | 451 | 452 |
|---|---|---|---|---|---|---|---|---|
| Days to Flower | 22 | 24 | 32 | 31 | 29 | 35 | 33 | 29 |
| Lifespan (days) | 83 | 83 | 87 | 87 | 87 | 87 | 87 | 87 |

TABLE 5m
Variety M, Maturity Group 5 (individual plant by plant datapoints)

| Plant ID | 453 | 454 | 455 | 456 | 457 | 458 | 459 | 460 |
|---|---|---|---|---|---|---|---|---|
| Days to Flower | 25 | 32 | 32 | 28 | 36 | 37 | 29 | 29 |
| Lifespan (days) | 83 | 83 | 83 | 83 | 87 | 87 | 87 | 87 |

### Treatment C Using 4.5-Inch Pots

TABLE 6
(averages for plants by variety and maturity group).

| Variety | MG | Average Days to Flower | Average Lifespan |
|---|---|---|---|
| A | 1 | 28 | 87 |
| B | 2 | 24.75 | 87 |
| C | 2 | 25.625 | 87 |
| D | 2 | 24.625 | 86.5 |
| E | 2 | 21.75 | 84.5 |
| F | 3 | 28.125 | 87 |
| G | 3 | 26.125 | 85 |
| H | 3 | 24.875 | 85 |
| J | 3 | 25.25 | 85 |
| K | 4 | 30.125 | 87 |
| L | 4 | 28.625 | 86 |
| M | 5 | 30 | 87 |

TABLE 6a
Variety A, Maturity Group 1 (individual plant by plant datapoints)

| Plant ID | 461 | 462 | 463 | 464 | 465 | 466 | 467 | 468 |
|---|---|---|---|---|---|---|---|---|
| Days to Flower | 25 | 26 | 25 | 26 | 28 | 33 | 30 | 31 |
| Lifespan (days) | 87 | 87 | 87 | 87 | 87 | 87 | 87 | 87 |

TABLE 6b
Variety B, Maturity Group 2 (individual plant by plant datapoints)

| Plant ID | 469 | 470 | 471 | 472 | 473 | 474 | 475 | 476 |
|---|---|---|---|---|---|---|---|---|
| Days to Flower | 24 | 25 | 25 | 25 | 25 | 24 | 25 | 25 |
| Lifespan (days) | 87 | 87 | 87 | 87 | 87 | 87 | 87 | 87 |

TABLE 6c
Variety C, Maturity Group 2 (individual plant by plant datapoints)

| Plant ID | 477 | 478 | 479 | 480 | 481 | 482 | 483 | 484 |
|---|---|---|---|---|---|---|---|---|
| Days to Flower | 26 | 26 | 25 | 28 | 25 | 25 | 25 | 25 |
| Lifespan (days) | 87 | 87 | 87 | 87 | 87 | 87 | 87 | 87 |

TABLE 6d
Variety D, Maturity Group 2 (individual plant by plant datapoints)

| Plant ID | 485 | 486 | 487 | 488 | 489 | 490 | 491 | 492 |
|---|---|---|---|---|---|---|---|---|
| Days to Flower | 25 | 25 | 24 | 20 | 24 | 25 | 25 | 29 |
| Lifespan (days) | 87 | 87 | 87 | 83 | 87 | 87 | 87 | 87 |

TABLE 6e
Variety E, Maturity Group 2 (individual plant by plant datapoints)

| Plant ID | 493 | 494 | 495 | 496 | 497 | 498 | 499 | 500 |
|---|---|---|---|---|---|---|---|---|
| Days to Flower | 20 | 21 | 20 | 24 | 24 | 24 | 21 | 20 |
| Lifespan (days) | 83 | 83 | 83 | 87 | 87 | 87 | 83 | 83 |

TABLE 6f
Variety F, Maturity Group 3 (individual plant by plant datapoints)

| Plant ID | 501 | 502 | 503 | 504 | 505 | 506 | 507 | 508 |
|---|---|---|---|---|---|---|---|---|
| Days to Flower | 28 | 28 | 28 | 28 | 28 | 29 | 28 | 28 |
| Lifespan (days) | 87 | 87 | 87 | 87 | 87 | 87 | 87 | 87 |

TABLE 6g
Variety G, Maturity Group 3 (individual plant by plant datapoints)

| Plant ID | 509 | 510 | 511 | 512 | 513 | 514 | 515 | 516 |
|---|---|---|---|---|---|---|---|---|
| Days to Flower | 25 | 29 | 25 | 24 | 29 | 29 | 24 | 24 |
| Lifespan (days) | 87 | 87 | 83 | 83 | 87 | 87 | 83 | 83 |

TABLE 6h
Variety H, Maturity Group 3 (individual plant by plant datapoints)

| Plant ID | 517 | 518 | 519 | 520 | 521 | 522 | 523 | 524 |
|---|---|---|---|---|---|---|---|---|
| Days to Flower | 25 | 26 | 24 | 24 | 26 | 26 | 22 | 26 |
| Lifespan (days) | 87 | 87 | 83 | 83 | 87 | 87 | 83 | 83 |

TABLE 6j
Variety J, Maturity Group 3 (individual plant by plant datapoints)

| Plant ID | 525 | 526 | 527 | 528 | 529 | 530 | 531 | 532 |
|---|---|---|---|---|---|---|---|---|
| Days to Flower | 28 | 28 | 24 | 22 | 26 | 28 | 24 | 22 |
| Lifespan (days) | 87 | 87 | 83 | 83 | 87 | 87 | 83 | 83 |

TABLE 6k
Variety K, Maturity Group 4 (individual plant by plant datapoints)

| Plant ID | 533 | 534 | 535 | 536 | 537 | 538 | 539 | 540 |
|---|---|---|---|---|---|---|---|---|
| Days to Flower | 28 | 28 | 28 | 28 | 28 | 28 | 36 | 37 |
| Lifespan (days) | 87 | 87 | 87 | 87 | 87 | 87 | 87 | 87 |

TABLE 6l
Variety L, Maturity Group 4 (individual plant by plant datapoints)

| Plant ID | 541 | 542 | 543 | 544 | 545 | 546 | 547 | 548 |
|---|---|---|---|---|---|---|---|---|
| Days to Flower | 28 | 31 | 29 | 26 | 30 | 31 | 29 | 25 |
| Lifespan (days) | 87 | 87 | 87 | 83 | 87 | 87 | 87 | 83 |

TABLE 6m
Variety M, Maturity Group 5 (individual plant by plant datapoints)

| Plant ID | 549 | 550 | 551 | 552 | 553 | 554 | 555 | 556 |
|---|---|---|---|---|---|---|---|---|
| Days to Flower | 28 | 28 | 29 | 28 | 26 | 33 | 31 | 37 |
| Lifespan (days) | 87 | 87 | 87 | 87 | 87 | 87 | 87 | 87 |

The figures further illustrate the results set forth in the Tables above. In particular, FIG. 2 graphically depicts the average number of flowers per day by treatment group. For all treatments, flowering nodes were measured Monday-Friday, but not on Saturday or Sunday. Flowering rates were estimated for Saturday and Sunday. As noted above, treatment groups A and B were exposed to no far-red light supplementation for the first 10 days of the plants' lives. Treatment B plants were placed in long day conditions on Day 30, but otherwise, received the same treatment as the plants in Treatment A. The plants subjected to treatment C were exposed to far-red light supplementation beginning on day 0. As FIG. 2 illustrates, Treatment C produced earlier flowering and more even flowering. This treatment approach is beneficial because the plant performance represented by the curve would provide researchers more time to conduct research related to flowering.

Treatments A and B produced similar data curves. For both, flowering occurred later and over a narrower window of time. This narrower performance curve exhibited by plants under Treatments A and B may be beneficial when researchers require a targeted flowering date.

FIG. 3 graphically depicts the average flower nodes per day separated for the four maturity groups of soy plants that received Treatment C. Maturity group 1 had an earlier peak of mean flower nodes per day, with a peak approximately around day 25. Maturity groups 2-4 had similar peaks of mean flower nodes, approximately occurring at day 27.

Overall, the data from Example 1 showed that the average first date of flower varied with the treatment the plant received. Plants that received Treatment C had the earliest date of first flowering, 26.5 days. Plants that received Treatment B had the next earliest average date of first flowering, 26.9 days. Plants that received Treatment A had the latest average date of first flowering, 27.2 days.

### Example 2-Comparison of 1.74 and 2.12 Red:Far-Red Ratios on Average Days to Flower

In Example 2, soy plants were divided into subset groups, with each subset receiving a different level of far-red light supplementation with a wavelength approximately 700-770 nm. All plants were exposed to approximately 430-470 μmol/m²/second of red light in short-day growing conditions during the growing period.

After 90 days of growth in the controlled environment, desirable phenotypic traits of each subgroup of plants are measured. Traits measurements may include, preferably, leaf size, plant height, flowering time, yield, and protein.

The purpose of this example was to further determine whether a ratio of red:far-red light of 2.12 would be as beneficial as 1.74. Among other things, 2.12 is about half-way between the successfully tested ratio of 1.74 and the unsuccessfully tested ratio of 2.59. Of course, it is possible that other ratios will also prove beneficial. A beneficial ratio will produce plants that are short in stature, but which still exhibit 6-8 pods per node and shorter internode growth.

Applicant hypothesized a 1.74 ratio of red:far-red supplementation would yield the largest benefits for soy plants. To determine an ideal red:far-red light ratio, Applicant measured the impacts of a ratio of 1.74 and a ratio of 2.12 on average seed count, percentage protein, and days to flower. Applicant compared 1.74 and 2.12 red:far-red supplementation for two varieties of soy one from Maturity Group 2 and one from MG 3 (n=94 soy plants for each Maturity Group). Light Intensity for red:far-red supplementation was approximately 250 μmol/m²/second. All plants were exposed to short day red:far-red light supplementation for all days of the plants' lives. All plants were grown in 3.5-inch pots, relative humidity was 55% during the day, and 60% during the night.

TABLE 7

| Red:Far-Red Ratio | Average Days to Flower | Average Lifespan |
|---|---|---|
| 1.74 | 27.48 | 91 |
| 2.12 | 27.19 | 91 |

As Table 7 shows there were no significant differences in days to flowering (senescence) between soy plants that received the 1.74 red:far-red treatment and those soy plants that received the 2.12 red:far-red treatment. Therefore, this example shows that the ratio of 2.12 was equivalent to 1.74.

### Example 3: Disclosed Method for Other Herbaceous Plants, Including Yellow Pea and Corn

The method disclosed above can be utilized for other herbaceous plants, including but not limited to yellow pea and corn, grown in a controlled growth environment. The inventors anticipate similar enhanced growing results for these other plants with an ideal red:far-red ratio of approximately 1.73-2.60. Inventors anticipate short day legumes, such as, without limitation, common bean, cowpea, pigeon pea, and peanut to respond to the disclosed red:far-red ratio. Inventors also anticipate long-day and day-neutral plants, such as, without limitation, pea, lentil, chickpea, faba bean, and lupin to respond to the disclosed red:far-red ratio. Inventors also anticipate other plants, such as tomato and corn to respond to the disclosed red:far-red ratio. The duration of the exposure of red:far-red supplementation will depend on whether the plant species is photoreceptive (such as short-day or long-day plants) or non-photoreceptive (day-neutral plants), and therefore when the particular plant tends to flower without red:far-red supplementation.

While particular embodiments of the present invention have been shown and described, it should be noted that changes and modifications may be made without departing from the presently disclosed inventive concepts in its broader aspects and, therefore, the aim in the appended claims is to cover all such changes and modifications as fall within the true spirit and scope of this invention.

The teachings herein are not limited to certain plant species, and it is envisioned that they can be modified to be useful for monocots, dicots, and/or substantially any crop and/or valuable plant type, including plants that can reproduce by self-fertilization and/or cross fertilization, hybrids, inbreds, varieties, and/or cultivars thereof. Some of example plant species include, soybeans (Glycine max), peas (Pisum sativum and other members of the Fabaceae like Cjanus and Vigna species), chickpeas (Cicer arietinum), peanuts (Arachis hypogaea), lentils (Lens culinaris or Lens esculenta), lupins (various Lupinus species), mesquite (various Proopis species), clover (various Trifolium species), carob (Ceratonia siliqua), tamarind, corn (Zea mays), Brassica sp. (e.g., B. napus, B. rapa, B. juncea), particularly those Brassica species useful as sources of seed oil, alfalfa (Medicago sativa), rice (Oryza sativa), rye (Secale cereale), sorghum (Sorghum bicolor, Sorghum vulgare), camelina (Camelina sativa), millet (e.g., pearl millet (Pennisetum glaucum), proso millet (Panicum miliaceum), foxtail millet (Setaria italica), finger millet (Eleusine coracana)), sunflower (Helianthus annuus), quinoa (Chenopodium quinoa), chicory (Cichorium intybus), tomato (Solanum lycopersicum), lettuce (Lactuca sativa), safflower (Carthamus tinctorius), wheat (Triticum aestivum), tobacco (Nicotiana tabacum), potato (Solanum tuberosum), peanuts (Arachis hypogaea), cotton (Gossypium barbadense, Gossypium hirsutum), sweet potato (Ipomoea batatus), cassava (Manihot esculenta), coffee (Coffea spp.), coconut (Cocos nucifera), pineapple (Ananas comosus), citrus trees (Citrus spp.), cocoa (Theobroma cacao), tea (Camellia sinensis), banana (Musa spp.), avocado (Persea americana), fig (Ficus casica), guava (Psidium guajava), mango (Mangifera indica), olive (Olea europaea), papaya (Carica papaya), cashew (Anacardium occidentale), macadamia (Macadamia integrifolia), almond (Prunus amygdalus), sugar beets (Beta vulgaris), sugarcane (Saccharum spp.), oil palm (Elaeis guineensis), poplar (Populus spp.), eucalyptus (Eucalyptus spp.), oats (Avena sativa), barley (Hordeum vulgare), flax (Linum usitatissimum), Buckwheat (Fagopyrum esculentum), vegetables, ornamentals, and conifers.

What is claimed is:

1. A method to enhance growth of a plant in a controlled growing environment, the controlled growing environment having a light source capable of illuminating the plant, comprising:
(a) selecting a first frequency for the light source, said first frequency being emitted at a first light intensity;
(b) selecting a second frequency for the light source, said second frequency being emitted at a second light intensity; and
(c) maintaining the first light intensity and the second light intensity at a predetermined ratio.

2. The method of claim 1, wherein the predetermined ratio is between 1.70-2.60.

3. The method of claim 2 wherein the predetermined ratio is 1.74.

4. The method of claim 1, wherein the first or second light intensity is greater than 800 μmol/m2/second.

5. The method of claim 4, wherein the first and second light intensity are greater than 800 μmol/m2/second.

6. The method of claim 4, wherein the first or second light intensity is greater than 1000 μmol/m²/second.

7. The method of claim 1, wherein the first light source frequency is selected from the range of approximately 620 to approximately 700 nanometers.

8. The method of claim 1, wherein the second light source frequency is selected from the range of approximately 700 to approximately 750 nanometers.

9. The method of claim 2 wherein the predetermined ratio is 2.12.
